(19) United States
(12) Patent Application Publication
(10) Pub. No.: US 2012/0321872 A1
(43) Pub. Date: Dec. 20, 2012

(54) TWO-COMPONENT WATER-BASED POLYURETHANE COMPOSITIONS AND COATINGS

(75) Inventors: Nitsa Nachshon-Galili, Kibbutz Geva (IL); Reut Sussan, Afula (IL)

(73) Assignee: PAZKAR LTD., Afula (IL)

(21) Appl. No.: 13/522,011

(22) PCT Filed: Jan. 13, 2011
(86) PCT No.: PCT/IL11/00043

§ 371 Date: Jul. 12, 2012

Related U.S. Application Data
(60) Provisional application No. 61/294,497, filed on Jan. 13, 2010.

(51) Int. Cl. C09D 175/06

(52) U.S. Cl. 428/220; 524/507

(57) ABSTRACT

There is provided herein a water-based two-component polyurethane dispersion prepared from combining (a) an aqueous polymer emulsion comprising one or more emulsifiable polymers and one or more polyols, wherein the aqueous polymer emulsion has a Tg lower than about 20 degree C. and (b) one or more isocyanates.

### FIELD OF THE INVENTION

The present invention relates to the field of polyurethane compositions, in particular to two-component water-based polyurethane compositions useful, for example for waterproofing and coating applications.

### BACKGROUND

Water based (sometimes referred to as waterborne) polyurethanes are known for a number of years and improvements of the compositions and properties of these materials are continuously being presented. Water based polyurethanes are commercially attractive for a number of reasons, one of the most important reason is the elimination or substantial reduction of solvents and volatile organic compounds (VOC) emissions into the atmosphere. Water based polyurethanes are also user friendly compared to the solvent containing polyurethans. Water-based polyurethanes can generally be divided into two main groups: one-component polyurethanes and two-component polyurethanes.

Examples of publications relating to one-component water-based polyurethanes include the following:

US20090137734 discloses an aqueous dispersion of polyurethane/acrylic polymer hybrid composites is made by forming a mixture of urethane prepolymer or polymer, acrylic monomer or polymer, ketone functional molecule/oligomers, and hydrazine functional molecule/oligomers; and dispersing the mixture so made in aqueous medium.

WO 2009105396 discloses water-based aromatic urethane-acrylic hybrid or composite compositions that are low or free from N-methyl pyrrolidone and generally free of volatile organic solvents in their preparation are disclosed. The use of ethylene glycol monoalkyl ether or propylene glycol monoalkyl ethers in preparing the dispersion, the use of ketone functional oligomers to improve the final dispersion quality and the use of acrylate monomer(s) to reduce the viscosity of the prepolymer are also taught.

US 20060234030 discloses an processes for damp proofing and waterproofing structures by the adhesion of a thin thermoplastic polyurethane (TPU) membrane to a belowgrade surface structure.

Two-component aqueous polyurethane dispersions are considered an important advancement in the polyurethane area. These dispersions are superior to well known one component aqueous dispersions of polyurethanes in which the polyurethanes are typically first formed in a solvent based system. The two-component water based polyurethanes, in addition to being user friendly, also match or exceed the performance of two-component solvent based polyurethane coatings while minimizing emission of organic solvents. In addition, the pot life of the product after mixing the two-components is much longer in water-based compositions than in solvent based compositions. The use of water based two-component polyurethane dispersions, thus provides more time for the user to apply the product after mixing and before it hardens. Among the examples of two-component water based polyurethane compositions disclosed in the art are the following:

EP 742239 discloses an improved two-component coating system—comprising water-based crosslinkable hydroxy terminated polyurethane prepolymer/hybrid containing acrylate units and polyisocyanate crosslinker. This coating system however, can result in a very thin layer (“The coating composition, which was applied in a wet film thickness of 300 μm (micrometer) (which corresponds to a dry film thickness of approximately 50 μm”), and thus cannot be suitable for certain applications, such as waterproofing applications.

EP 1 101 781 discloses a substantially solvent free, aqueous, pigmented, two-component polyurethanepolyurea dispersion comprising: (a) an aqueous mixture of an acid-containing polymeric polyol and a polyol free of acid groups, wherein the mixture has an average hydroxyl functionality of at least 1.5 and an acid number an amine or a blend of amines having an average between about 15 and 200 and active hydrogen functionality of at least 1.5, the amine or blend of amines being present in a sufficient amount to substantially neutralize the acid-containing polymeric polyol, (b) one or more polyisocyanates, and (c) two or more different pigments, characterized by reducing or eliminating flooding of (d) an aqueous polymer emulsion present in an amount the pigments with sufficient to impart thixotropy to the mixture of (a) and (d). EP 1 101 781 discloses aqueous polymer emulsions which “ . . . can comprise a polymer or mixture of polymers, preferably having a Tg greater than ambient temperature; i.e., greater than about 20° C.” The resulting coatings will thus have high hardness properties and low flexibility and elongation properties.

There still remains an unmet need in the art for water-based polyurethane compositions exhibiting desired chemical and physical properties depending on their intended application.

### SUMMARY

The present invention relates to polyurethane compositions, in particular to two-component water-based polyurethane compositions, which may be useful, for example, for coating and waterproofing applications. Specifically, the two-component water-based polyurethane compositions, according to some embodiments of the invention, may be used for providing a thick paste forming a seamless, water resistant flexible coating membrane.

The two-component water-based polyurethane compositions, according to some embodiments of the invention, comprises essentially no volatile organic compounds (VOC), and exhibits performance properties that closely match those of solvent borne polyurethanes. The polyurethane dispersions produced by the two-component water-based polyurethane compositions, according to some embodiments, have high adhesive qualities to many substrates as well as high strength comparing with conventional polymeric coatings. Among other advantages of the polyurethane dispersions, according to some embodiments, are resistance to extreme temperatures, resistance to large scale of chemicals, high elasticity, flexible enough to bridge cracks even at low temperature, enough strength to withstand physical pressure and stresses, high ultraviolet (UV) resistance, high solar reflectance and infrared emittance, high productivity, ability to cover a wide area in a short time, environmentally friendly, easy mixing, and easy application. In addition, the polyurethane dispersions, according to some embodiments of the invention, may be applied to both vertical and horizontal surfaces, for example, with a brush or an airless spray. The polyurethane dispersions may also saves the need of an additional white coat. Moreover, the pot life of the mixing product of the water-based two-component dispersions is much longer than that of the solvent based two-component dispersions.

In another aspect, the present invention provides a water-based two-component polyurethane dispersion prepared from combining (a) an aqueous polymer emulsion comprising one or more emulsifiable polymers and, as separate components, one or more polyols, wherein the aqueous polymer emulsion has a Tg lower than about 20° C. and (b) one or more isocyanates.

In another aspect, the present invention provides a composition for the preparation of water-based two-component polyurethane dispersion, the composition comprising an aqueous polymer emulsion comprising one or more emulsifiable polymers (such as, for example, acrylic polymers, flexible polyolefins, natural or synthetic rubber and other emulsifiable polymers or combination thereof) and, as separate components, one or more polyols, wherein the composition has a Tg lower than about 20° C., wherein the composition is adapted to be combined with one or more isocyanates for the preparation of water-based two-component polyurethane dispersion. The term “isocyanates” may refer to a compound having —NCO group(s).

Emulsifiable polymers as referred to herein may include, for example, acrylic polymers, flexible polyolefins, natural or synthetic rubber and other emulsifiable polymers or combination thereof.

According to some embodiments, the one or more emulsifiable polymers comprise an acrylic polymer.

According to some embodiments, the composition may have a Tg in the range of about 15° C. to −30° C. (for example, 15° C. to 0° C. or 10° C. to 5° C.). According to some embodiments, the ratio between the OH groups content in the one or more polyols in the composition and the —NCO groups content of the one or more polyisocyanates may be in the range of about 1:3 to about 1:15. The ratio between the OH groups content in the one or more polyols in the composition and the —NCO groups content of the one or more polyisocyanates may in the range of about 1:4 to about 1:10.

In another aspect, the present invention provides a process for the preparation of water-based two-component polyurethane dispersion, the process comprising combining (a) an aqueous polymer emulsion comprising one or more emulsifiable polymers and one or more polyols, wherein the aqueous polymer emulsion has a Tg lower than about 20° C. and (b) one or more isocyanates.

In another aspect, the present invention provides a use of water-based two-component polyurethane dispersion prepared from combining (a) an aqueous polymer emulsion comprising one or more emulsifiable polymers and one or more polyols, wherein the aqueous polymer emulsion has a Tg lower than about 20° C. and (b) one or more isocyanates, as a water resistant coating (such as a film, membrane or the like, for example for waterproofing applications).

According to some embodiments, the dispersion may have a Tg in the range of about 15° C. to −30° C. (for example, 15° C. to 0° C. or 10° C. to 5° C.). According to some embodiments, the ratio between the OH groups content in the one or more polyols in the dispersion and the —NCO groups content of the one or more polyisocyanates may be in the range of about 1:3 to about 1:15. The ratio between the OH groups content in the one or more polyols in the dispersion and the —NCO groups content of the one or more polyisocyanates may in the range of about 1:4 to about 1:10.

According to some embodiments, the OH groups content in the one or more polyols in the aqueous polymer emulsion may in the range of 0.01%-5%. The OH groups content in the one or more polyols in the aqueous polymer emulsion may be in the range of 0.01%-1%. The OH groups content in the one or more polyols in the aqueous polymer emulsion may be in the range of about 0.1%-0.5%.

According to some embodiments, the one or more polyols may be provided from (for example, may be a chemical modification of) one or more water soluble polyesters, polyester emulsions, polyurethane dispersions, fatty acid modified polyurethane dispersion, polyester/polyacrylate hybrids, polyester/polyurethane hybrids, primary polyacrylic emulsions, secondary polyacrylic emulsions or any combinations thereof. The one or more acrylic polymers may comprise acrylates selected from the group consisting of butyl acrylate, 2-ethylhexyl acrylate, methyl acrylate, ethyl acrylate, acrylonitrile, methyl methacrylate, vinyl acrylate and trimethylolpropane triacrylate.

The acrylic copolymers may comprise copolymers of acrylics with styrene, substituted styrene, vinyl chloride, vinyl acetate, butadiene, acrylonitrile butyl acrylate, methyl acrylate, vinyl acrylate, 2-ethylhexyl acrylate, ethyl acrylate, methyl methacrylate, trimethylolpropane triacrylate or any combination thereof.

The one or more acrylic polymers may include acrylic copolymer. The acrylic copolymer may include polystyrene acrylate copolymer.

According to some embodiments, the aqueous polymer emulsion may further comprise one or more of vinyl acetate polymers, vinyl acetate copolymers, ethylene copolymers, alkyd resins, polyamides, polyacetals, polycarbonates, polyketones, polyethers, polyurea polyurethanes or any combinations thereof.

According to some embodiments, the one or more isocyanates may comprise polyisocyanates. The one or more isocyanates may comprise aliphatic isocyanates, cycloaliphatic isocyanates, aromatic isocyanates, or any combination thereof. The one or more isocyanates may comprise methylene diphenyl diisocyanate (MDI), toluene diisocyanate (TDI), hexamethylene diisocyanate (HDI) and isophorone diisocyanate (IPDI) or any combination thereof. Polyisocyanates of the foregoing are also contemplated.

According to some embodiments, the water-based two-component polyurethane dispersion may be adapted for application as a water resistant layer.

According to some embodiments, the water-based two-component polyurethane dispersion is adapted for application as a water resistant isolation layer having a thickness of about 0.1 millimeter (mm) or more (for example, 0.2, 0.3, 0.4 0.5, 1, 2, 3, between about 2 and 3 mm, or more). According to some embodiments, the thickness of the water resistant isolation substance (may also be referred to as coating substance) refers to the dry film thickness.

In another aspect, the present invention provides an essentially water resistant coating substance comprising water-based two-component polyurethane dispersion prepared from combining (a) an aqueous polymer emulsion comprising one or more emulsifiable polymers and, as separate components, one or more polyols, wherein the aqueous polymer emulsion has a Tg lower than about 20° C. and (b) one or more isocyanates.

According to some embodiments, the essentially water resistant coating substance may have a thickness of about 0.1 millimeter (mm) or more (for example, 0.2, 0.3, 0.4 0.5, 1, 2, 3, between about 2 and 3 mm, or more). According to some embodiments, the thickness of the water resistant coating substance refers to the dry film thickness.

According to some embodiments, the essentially water resistant coating substance may have cold flexibility lower than −10° C. (according to ASTM D 522 standard). According to some embodiments, the essentially water resistant coating substance may have tensile strength higher than 2.0 Mpa (according to ASTM D 412 standard). According to some embodiments, the essentially water resistant coating substance may have elongation at break higher than 100% (according to ASTM D 412 standard). According to some embodiments, the essentially water resistant coating substance may have water absorption lower than 10% (according to DIN 53495 standard).

### DETAILED DESCRIPTION

### Glossary

The term “polyurethane” may refer to a generic term used to describe polymers including oligomers which contain the urethane group, —O—C(═O)—NH—, regardless of how they are made.

The term “Polyol” may refer to any compound having an average of about two or more hydroxyl (OH) groups per molecule.

The symbol “%” (percent), unless specified otherwise refers to “Wt. %” which means the number of parts by weight of an ingredient per 100 parts by weight of a composition, dispersion or any material of which the ingredient forms a part.

The term “aqueous” or “water-based” may refer to any water-based substance or medium, for example, water based solution, emulsion, dispersion or the like.

The term “polymer” may refer to large molecule (macromolecule) composed of repeating structural units typically connected by covalent bonds. Polymer(s), as referred to herein, may include heteropolymers (copolymers) which are polymers derived from two (or more) monomeric species and homopolymer which are built from one monomeric species.

The term “emulsion” may refer to mixture of two or more substances (for example, liquids or liquid(s) and solid(s)) that are at least partially immiscible (unblendable) with each other. The term emulsion may include a suspension and dispersion.

The term “Tg” or “glass transition temperature” may refer to the critical temperature at which the material changes its behavior from being “glassy” (for example, hard and brittle and thus relatively easy to break) to being “rubbery” (for example, elastic and flexible).

The term “acrylic polymers” may include polymers (including copolymers) having repeating units derived from polymerizing monomers from the group of acrylic acid, acrylates (salts or esters of acrylic acid), and alkacrylates such as methacrylates and ethacrylates. The acrylic polymer or copolymer can be from a variety of unsaturated monomers such as, but not limited to, from acrylate, alkyl (alk)acrylate, vinyl chloride, vinylidene chloride, vinyl acetate, styrene, butadiene, vinyl acetate and/or unsaturated acid containing monomers.

The term “acrylic emulsion” or “polyacrylic emulsion” may refer to an emulsion comprising an acrylic polymer.

According to some embodiments, the present invention relates to two-component water-based (aqueous) polyurethane dispersions, which may be useful, for example, for coating applications such as forming flexible coating membranes. According to some embodiments, the water-based two-component polyurethane dispersions are prepared from combining an aqueous polymer emulsion containing polyols having OH groups (component A) with one or more polyisocyanates (component B), wherein the aqueous polymer emulsion (component A) is characterized by a Tg which is lower than 20° C. The low Tg of component A contributes to the flexibility of the coating membrane which can be produced using the dispersion. According to some embodiments, it may be assumed that the relatively low content of OH groups in component A and in particular the relatively high ratio between acrylic emulsion and polyol in component A, contributes to the low Tg and flexibility properties of the coating products. According to some embodiments, the ratio between the acrylic emulsion and the polyol in component A may be about 1-10:1.

### Aqueous Polymer Emulsion (Component A)

### Polyols

As discussed herein the aqueous polymer emulsion (component A) contains polyols. The term “Polyol” may refer to any compound having an average of about two or more hydroxyl (OH) groups per molecule. Examples of polyols include low molecular weight products called “extenders” with number average molecular weight less than about 500 Dalton such as aliphatic, cycloaliphatic and aromatic polyols, for example diols, having 2-20 carbon atoms, such as 2-10 carbon atoms, as well as “macroglycols,” which include polymeric polyols having molecular weights of at least 500 Daltons, for example, about 1,000-10,000 Daltons, such as 1,000-6,000 Daltons. Examples of such macroglycols may include polyester polyols including alkyds, polyether polyols, polycarbonate polyols, polyhydroxy polyester amides, hydroxyl-containing polycaprolactones, hydroxyl-containing acrylic polymers, hydroxyl-containing epoxides, polyhydroxy polycarbonates, polyhydroxy polyacetals, polyhydroxy polythioethers, polysiloxane polyols, ethoxylated polysiloxane polyols, polybutadiene polyols and hydrogenated polybutadiene polyols, polyisobutylene polyols, polyacrylate polyols, halogenated polyesters and polyethers, and the like, and any mixtures or combinations thereof. One or more of the polyols may be provided from one or more water soluble polyesters, polyester emulsions, polyurethane dispersions, fatty acid modified polyurethane dispersion, polyester/polyacrylate hybrids, polyester/polyurethane hybrids, primary polyacrylic emulsions, secondary polyacrylic emulsions or any combinations thereof. According to some embodiments, the polyols may be provided from Bayhydrol A 2457 (Bayer Corporation).

Examples of diols may include but are not limited to polyester diols, which include any compound containing the —C(═O)—O— group. Examples of polyester diols include but are not limited to poly(butanediol adipate), caprolactones, acid-containing polyols, polyesters made from hexane diol, adipic acid and isophthalic acid such as hexane adipate isophthalate polyester, hexane diol neopentyl glycol adipic acid polyester diols, for example, Piothane 67-3000 HAI, Piothane 67-500 HAI, Piothane 67-3000 HNA (Panolam Industries) and Piothane 67-1000 HNA; as well as propylene glycol maleic anhydride adipic acid polyester diols, for example, Piothane 50-1000 PMA; and hexane diol neopentyl glycol fumaric acid polyester diols, for example Piothane 67-500 HNF. Other polyester diols include Rucoflex™. S1015-35, S1040-35, and S-1040-110 (Bayer Corporation).

The polyester polyols may be esterification products prepared by the reaction of organic polycarboxylic acids or their anhydrides with a stoichiometric excess of a diol or diols. Examples of suitable polyols for use in the reaction include poly(glycol adipate)s, poly(ethylene terephthalate) polyols, polycaprolactone polyols, alkyd polyols, orthophthalic polyols, sulfonated and phosphonated polyols, and the like, and mixtures thereof.

The diols used in making the polyester polyols include alkylene glycols, for example, ethylene glycol, 1,2- and 1,3-propylene glycols, 1,2-, 1,3-, 1,4-, and 2,3-butylene glycols, hexane diols, neopentyl glycol, 1,6-hexanediol, 1,8-octanediol, and other glycols such as bisphenol-A, cyclohexane diol, cyclohexane dimethanol (1,4-bis-hydroxymethylcycohexane), 2-methyl-1,3-propanediol, 2,2,4-trimethyl-1,3-pentanediol, diethylene glycol, triethylene glycol, tetraethylene glycol, polyethylene glycol, dipropylene glycol, polypropylene glycol, dibutylene glycol, polybutylene glycol, dimerate diol, hydroxylated bisphenols, polyether glycols, halogenated diols, and the like, and mixtures thereof. Preferred diols include ethylene glycol, diethylene glycol, butylene glycol, hexane diol, and neopentyl glycol.

Suitable carboxylic acids used in making the polyester polyols include dicarboxylic acids and tricarboxylic acids and anhydrides, for example, maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, and mixtures thereof. Preferred polycarboxylic acids used in making the polyester polyols include aliphatic and/or aromatic dibasic acids.

Examples of diols may include but are not limited to polyether diols, which include any compound containing a —C—O—C— group. They can be obtained in a known manner by the reaction of (A) the starting compounds that contain reactive hydrogen atoms, such as water or the diols set forth for preparing the polyester polyols, and (B) alkylene oxides, such as ethylene oxide, propylene oxide, butylene oxide, styrene oxide, tetrahydrofuran, epichlorohydrin, and the like, and mixtures thereof. Examples of polyethers include poly(propylene glycol), polytetrahydrofuran, and copolymers of poly(ethylene glycol) and poly(propylene glycol).

Examples of polyols may include but are not limited to polycarbonate polyols, which include any compound containing a —O—C(═O)—O— group. They can be obtained, for example, from the reaction of (A) diols such as 1,3-propanediol, 1,4-butanediol, 1,6-hexanediol, diethylene glycol, triethylene glycol, tetraethylene glycol, and the like, and mixtures thereof with (B) diarylcarbonates such as diphenylcarbonate or phosgene. Aliphatic and cycloaliphatic polycarbonate polyols can also be used.

Low molecular weight alkylene polyols (for example, glycerol, trimethylol propane, etc.) can be used as urethane branching agents. Branching can provide beneficial properties to a urethane polymer and can provide additional functional (reactive) end groups (generally above 2 as one goes from a linear oligomers to a branched oligomers or polymer) for each urethane prepolymer or polymer.

According to some embodiments, the OH groups content in the aqueous polymer emulsion (A) may be in the range of 0.01%-5%, for example, in the range of 0.01%-1%, in the range of 0.1%-0.5% or in the range of 0.5%-2%. For example, the polyols of the aqueous polymer emulsion (component A) may be provided from Bayhydrol A 2457 (Bayer Corporation), which includes anionic polyacrylate primary dispersion 40% in water, having OH content of about 2% regarding the percentage of solid resin in the dispersion. When aqueous polymer emulsion (component A) contains 12.5% of Bayhydrol A2457, the percentage of solids of Bayhydrol A2457 is 5% (calculated by 0.40*12.5%) and thus the percentage of OH content in component A is 0.1% (calculated by 0.02*5%).

### Other Polymers

As discussed herein the aqueous polymer emulsion (component A) may also include other polymers, for example, for forming hybrids of polyurethanes with other polymers. According to some embodiments, the aqueous polymer emulsion (component A) may include acrylics (acrylic polymers) which may include repeating units derived from polymerizing monomers from the group of acrylic acid, acrylates (salts or esters of acrylic acid), and alkacrylates such as methacrylates and ethacrylates. The acrylic polymer or copolymer can be from a variety of unsaturated monomers such as from acrylate, alkyl (alk)acrylate, vinyl chloride, vinylidene chloride, vinyl acetate, styrene, butadiene, vinyl acetate and/or unsaturated acid containing monomers. Examples of acrylic esters include methyl acrylate, ethyl acrylate, propyl acrylate, n-butyl acrylate, isobutyl acrylate, n-pentyl acrylate, isoamyl acrylate, n-hexyl acrylate, 2-methylpentyl acrylate, n-octyl acrylate, 2-ethylhexyl acrylate, n-decyl acrylate, n-dodecyl acrylate, n-octadecyl acrylate, and the like. Preferred examples include ethylacrylate, butyl acrylate, 2-ethyl hexyl acrylate, and the like. Examples of alkyl (alk)acrylates include methyl methacrylate, ethyl methacrylate, methoxymethyl acrylate, methoxyethyl acrylate, ethoxyethyl acrylate, butoxy ethyl acrylate, ethoxypropyl acrylate, and the like. Derivatives include hydroxyethyl acrylate, hydroxypropyl acrylate, hydroxybutyl acrylate, and the like. Mixtures of two or more of the above monomers can also be utilized.

The aqueous polymer emulsion (component A) may further include vinyl acetate polymers, vinyl acetate copolymers, ethylene copolymers, alkyd resins, polyamides, polyacetals, polycarbonates, polyketones, polyethers, polyurea polyurethanes and polyesters including polyester polyols or any mixtures thereof.

Any compound or compound family referred to herein (for example, alkyl, aryl or the like) may be substituted or unsubstituted.

### Dispersion Agents

Polyurethanes are generally hydrophobic and not water-dispersible. In accordance with some embodiment of the invention, therefore, at least one water-dispersion agent (dispersibility enhancing compound) (for example, a monomer), which has at least one, hydrophilic (for example, poly(ethylene oxide)), ionic or optionally, ionic groups are included in the polyurethane prepolymer to assist dispersion of the polyurethane prepolymer in water, thereby enhancing the stability of the dispersions made. Often these are diols or polyols containing water dispersibility enhancing functionality. For example, a compound bearing at least one hydrophilic group or a group that can be made hydrophilic (for example, by chemical modifications such as neutralization) may be incorporated into the polymer chain. These compounds may be of a nonionic, anionic, cationic or zwitterionic nature or the combination thereof. For example, anionic groups such as carboxylic acid groups can be incorporated into the prepolymer in an inactive form and subsequently activated by a salt-forming compound such as a tertiary amine. Other water-dispersibility enhancing compounds can also be reacted into the prepolymer backbone through urethane linkages or urea linkages, including lateral or terminal hydrophilic ethylene oxide or ureido units.

Water dispersibility enhancing compounds of particular interest are those which can incorporate carboxyl groups into the prepolymer. Examples of such hydroxy-carboxylic acids include dimethylolpropanoic acid (DMPA), dimethylol butanoic acid (DMBA) (most preferred), citric acid, tartaric acid, glycolic acid, lactic acid, malic acid, dihydroxymalic acid, dihydroxytartaric acid, and the like, and mixtures thereof.

Water dispersibility enhancing compounds may include reactive polymeric polyol components that contain pendant anionic groups which can be polymerized into the prepolymer backbone to impart water dispersible characteristics to the polyurethane subsequent to chain extension. The term anionic functional polymeric polyol includes anionic polyester polyols, anionic polyether polyols, and anionic polycarbonate polyols.

These polyols include moieties that contain active hydrogen atoms. Such polyols containing anionic groups are described in U.S. Pat. No. 5,334,690, which is incorporated herein by reference in its entirety. Another group of water-dispersibility enhancing compounds of particular interest are side chain hydrophilic monomers (nonionic dispersibility enhancing components). Some examples include alkylene oxide polymers and copolymers in which the alkylene oxide groups have from 2-10 carbon atoms as shown in U.S. Published Patent Application No. 20030195293 to Noveon, Inc, which is incorporated herein by reference in its entirety. Other suitable water-dispersibility enhancing compounds include thioglycolic acid, 2,6-dihydroxybenzoic acid, sulfoisophthalic acid or combinations thereof. According to some embodiments, nonyl phenol ethoxylates may also be used as a dispersibility enhancing components.

### Compounds Having at Least One Crosslinkable Functional Group

According to some embodiments, compounds having at least one crosslinkable functional group may be incorporated into the polyurethane prepolymers. Examples of such compounds include those having carboxylic, carbonyl, amine, hydroxyl, epoxy, acetoacetoxy, urea-formaldehyde, auto-oxidative groups that crosslink via oxidization, ethylenically unsaturated groups optionally with (ultraviolet) U.V. activation, olefinic and hydrazide groups, and the like, and mixtures of such groups and the same groups in protected forms (so crosslinking can be delayed until the composition is in its application (e.g., applied to a substrate) and coalescence of the particles has occurred) which can be reversed back into original groups from which they were derived (for crosslinking at the desired time). Other suitable compounds providing crosslinkability include thioglycolic acid, 2,6-dihydroxybenzoic acid, and the like, and mixtures thereof.

### Catalysts

The prepolymer may be formed with or without the use of a catalyst. Examples of catalysts may include: amine compounds and organometallic complexes.

### Other Additives for Preparation of Dispersions

Other additives well known to those skilled in the art can be used to aid in preparation of the dispersions according to some embodiments of this invention. Such additives may include stabilizers, fillers, defoamers (anti foam agents), antioxidants, UV absorbers, carbodiimides, activators, curing agents, leveling agent, stabilizers such as carbodiimide, colorants, pigments, neutralizing agents, thickeners, non-reactive and reactive plasticizers, coalescing agents, waxes, slip and release agents, antimicrobial agents, surfactants, metals, coalescents, salts, flame retardant additives, pestecides, and the like. They can optionally be added as appropriate before and/or during the processing of the dispersions of this invention into finished products as is well known to those skilled in the art. Additives may also be used as appropriate in order to make articles or to treat other products (such as by impregnation, saturation, spraying, coating, or the like).

### One or More Polyisocyanates (Component B)

According to some embodiments, suitable polyisocyanates may have an average of about two or more isocyanate groups, for example an average of about two to about four isocyanate groups per molecule and comprising about 5 to 20 carbo atoms (in addition to nitrogen, oxygen, and hydrogen) and include aliphatic, cycloaliphatic, araliphatic, and/or aromatic polyisocyanates, as well as products of their oligomerization, used alone or in any combinations or mixtures of two or more. According to some embodiments, suitable polyisocyanates diisocyanates may be used.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can also be used but may be less preferred because of their high volatility and toxicity. Preferred aliphatic polyisocyanates include hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates may include dicyclohexylmethane diisocyanate, (commercially available as Desmodur™ W from Bayer Corporation), isophorone diisocyanate, 1,4-cyclohexane diisocyanate, 1,3-bis-(isocyanatomethyl)cyclohexane, and the like. Cycloaliphatic polyisocyanates may include dicyclohexylmethane diisocyanate and isophorone diisocyanate.

Specific examples of suitable araliphatic polyisocyanates may include m-tetramethyl xylylene diisocyanate, p-tetramethyl xylylene diisocyanate, 1,4-xylylene diisocyanate, 1,3-xylylene diisocyanate, and the like. Araliphatic polyisocyanate may include tetramethyl xylylene diisocyanate.

Examples of suitable aromatic polyisocyanates may include 4,4′-diphenylmethylene diisocyanate, toluene diisocyanate, their isomers, naphthalene diisocyanate, their oligomeric forms and the like. A preferred aromatic polyisocyanate is toluene diisocyanate.

Examples of suitable isocyanates may include methylene diphenyl diisocyanate (MDI), toluene diisocyanate (TDI), hexamethylene diisocyanate (HDI) and isophorone diisocyanate (IPDI).

### Ingredient Proportions

According to some embodiments of the invention, the ratio between the OH groups content in the aqueous polymer emulsion (A) and the —NCO groups of the one or more polyisocyanates (B) is in the range of about 1:3 to about 1:15, for example, in the range of about 1:4 to about 1:10, in the range of about 1:6 to about 1:9.5, or more specifically about 1:9:25.

An example of the OH:NCO ratio calculation may be as follows: the polyols of the aqueous polymer emulsion (component A) may be provided from Bayhydrol A 2457 (Bayer Corporation), which includes anionic polyacrylate primary dispersion 40% in water, having OH content of about 2% regarding solid resin. When aqueous polymer emulsion (component A) contains 12.5% of Bayhydrol A2457, the percentage of solids in Bayhydrol A2457 is 5% (calculated by 0.40*12.5%) and thus the percentage of OH content in component A is 0.1% (calculated by 0.02*5%). The NCO content in component B (Bayhydur XP 2451, 100% solids) is 18.5%. When the mixing ration of A:B (component A:component B) is 1:20 the NCO percentage is accordingly divided by 20 and is therefore 0.925%. The OH:NCO ratio in this example is thus 1:9.25.

### The Process of Preparing Two-Component Water-Based Polyurethane Membranes

According to some embodiments of the invention, in order to formulate the aqueous polymer emulsion (Component A) the polyolic component is preferably blended with the acrylate emulsion and the additives in a mixing tank under continuous shear, resulting in a homogenous mixture. The viscosity of the resulting mixture may then be adjusted to a desired level, for example, 45,000-50,000 cP, as detailed in Example 8 hereunder. This aqueous polymer emulsion can be combined with one or more polyisocyanates (component B) to form water-based, two-component polyurethane dispersion. After addition of the polyisocyanate, the obtained substance has a limited pot life within which it should be applied to a substrate. Typically the pot life is about 3 hours but may be shorter or longer for example 1-6 hours according to weather conditions. The obtained substance may apply as a thick paste by one, two or more layers. When applying more than one layer each may have the same or different color in order to ensure that a complete layer has been applied. Application can be made by using conventional methods such as the use of a brush, spray (such as airless spray) or by any other method. The material rheology may vary, depending on the application method. For example, self leveling coating materials for floors produce a smooth, level floor surface to facilitate the effective application of floor coverings. Upon pouring the materials onto the floor surface, the materials begin flowing on their own to cover the floor surface. It has been observed that the relatively low OH percentage in the aqueous polymer emulsion contributes to a high thickness of an individual layer. After providing the appropriate drying time (for example, 4-6 hours) a flexible membrane is formed, having properties which may be equal to or exceed solvent-based two-component polyurethanes. The membrane may also be seamless or decorative. According to some embodiments, the properties of the formed membrane may include, for example, a good cold flexibility, high elongation at break, high tensile strength, high chemical resistance (for example, to Acetic acid 10%, Acetone, Ammonia, aqueous 25%, Diesel fuel, Ethanol, Gasoline Glycerin, Hexane, Hydrochloric acid 10%, Sulfuric Acid 10%, Sulfuric Acid 2%, NaOH 0.1% or any combination thereof, as measured after immersing films according to embodiments of the inventions in such solutions), good adhesion to different surfaces and/or resistance to UV.

According to some embodiments of the invention, it may be assumed that the acrylic emulsion, in particular the relatively high ratio between acrylic emulsion and polyol, contributes to at least some of the mentioned properties. According to some embodiments, the ratio between the acrylic emulsion and the polyol in component A may be about 1-10:1.

### Applications of the Two-Component Water-Based Polyurethane Membranes

As discussed above, and according to some embodiments, after mixing Component A with Component B, the obtained dispersion has a limited pot life within which it should be applied to a substrate. Typically the pot life of the substances according embodiments of the invention, are longer than those of known substances and may be about 3 hours but may also be shorter or longer for example 1-6 hours depending on weather conditions. The obtained substance may apply as a thick paste by one, two or more layers. When applying more than one layer each may have the same or different color in order to ensure that a complete layer has been applied. Application can be made by using conventional methods such as the use of a brush, roller, spray (such as airless spray) or by any other method.

The two-component water-based polyurethane membranes, according to some embodiments, may be used for various applications, for example, for coating and/or isolating purposes. Other applications include paints for interior or exterior walls as well as for road markings. Coating products, prepared according to embodiments of the invention, can be formed as water-resistant isolation layers which can be used for example, for waterproofing surfaces such as walls, roofs, water reservoir and tanks or other surfaces. Coating products, prepared according to embodiments of the invention, can also be used for waterproofing complex geometrical shapes where bituminous membranes or other membranes cannot be used. Other advantages of coating membranes produced from the two-component water-based polyurethane dispersions, according to embodiments of the invention, may include resistance to extreme temperatures and to ponding water, high solar reflectance and infrared emittance, high ultraviolet (UV) resistance, low dust pickup, high adhesive qualities to many substrates as well as high strength comparing with conventional polymeric coatings. Among other advantages of the products (for example coating films) produced from the polyurethane dispersions, according to some embodiments, are resistance to large scale of chemicals, high elasticity, flexible enough to bridge cracks even at low temperature, enough strength to withstand physical pressure and stresses, high productivity, ability to cover a wide area in a short time, environmentally friendly, easy mixing, and easy application. In addition, the polyurethane dispersions, according to some embodiments of the invention, may be applied to both vertical and horizontal surfaces, for example, with a brush or an airless spray. The polyurethane dispersions may also saves the need of an additional white coat. Moreover, the pot life of the mixing product of the water-based two-component dispersions is much longer than that of the solvent based two-component dispersions.

### EXAMPLES

The following examples, describe various compositions and processes for the reparation of water-based two-component polyurethane dispersion, according to embodiments of the invention.

### COMPARATIVE EXAMPLES

### Example 1

### Composition Commonly Used in the Art

According to some non-limiting embodiments, a composition was prepared according to Bayer's recommended process. The composition included Component A—a mixture containing 60% Bayhydrol A 2457 and additive materials and Component B—10% isocyanate. The ratio between Component A and Component B was 10:1. The materials and percentages used for the preparation of water-based two-component polyurethane film are summarized in Table 1.

TABLE 1
Materials and percentages

| Ingredient | % |
|---|---|
| Component A | |
| Polyacrylate dispersion 2% OH content | 60 |
| (Bayhydrol A 2457) | |
| NXZ Defoamer | 2 |
| Water (deionized) | 30.5 |
| CERECLOR (Plastisizer) | 4.5 |
| ACRYSOL RM 825 (Thickener) | 2.5 |
| Diethylene glycol | 0.5 |
| Component B | |
| Hexamethylene diisocyanate (HDI) | 10 |

Controlled thickening was not performed in this experiment, and pigments were not used. The obtained material was transparent, diluted and difficult to implement.

### Example 2

A composition was prepared wherein Component A included a hybrid polymer paste and did not include any polyolic component. Component B was added in a similar ratio as in Example 1, at of 10:1 between Component A and Component B. The materials and range of percentages used for the preparation of water-based two-component polyurethane film are summarized in Table 2.

TABLE 2
Materials and percentages

| Ingredient | % |
|---|---|
| Component A | |
| Pigments | 2.5-10 |
| Filler | 15-40 |
| Styrene acrylate emulsion 50% solids, Tg < 20 | 30-60 |
| Pure acryl Tg < 0 | 5-20 |
| Polyester polyurethane dispersion | 2-10 |
| Additives—thickener, dispersing agent, | ~2-5 |
| Anti foam, and biocides | |
| Water (deionized) | ~0.2-2 |
| Component B | |
| HDI | 10 |

Long drying time was obtained for this composition, as expected for a component A which does not contain polyols (free OH groups), and does not enable the occurrence of a polyurethane-producing reaction between the components.

### Example 3

This experiment resulted from the combination of the previous two experiments. The hybrid polymer composition was modified while introducing 60% polyol, similar to the percentage recommended by Bayer. The materials and percentages used for the preparation of water-based two-component polyurethane film are summarized in Table 3.

TABLE 3
Materials and percentages

| Ingredient | % |
|---|---|
| Component A | |
| Pigment | 2.5 |
| Filler | 33.6 |
| Polyacrylate dispersion 2% OH content | 60.0 |
| Additives—thickener, dispersing agent, | ~3.5-4 |
| Anti foam, and biocides | |
| Water (deionized) | ~0.2 |
| Component B | |
| HDI | 10 |

Fast drying was obtained for this composition. However, the resulting film was very rigid, and was distorted and folded during the drying period in a way that did not allow further examination of its properties.

### EXAMPLES

### Example 4

According to some non-limiting embodiments, in order to increase the flexibility of the film obtained in Example 3, Styrene acrylate emulsion was introduced to the mixture without affecting the solids percentage of the entire polymers. The materials and percentages used for the preparation of water-based two-component polyurethane film are summarized in Table 4.

TABLE 4
Materials and percentages

| Ingredient | % |
|---|---|
| Component A | |
| Pigment | 2.5 |
| Filler | 39.6 |
| Styrene acrylate emulsion 50% solids, Tg < 20 | 24.0 |
| Polyacrylate dispersion 2% OH content | 30.0 |
| Additives—thickener, dispersing agent, | ~3.5-4 |
| Anti foam, and biocides | |
| Water (deionized) | ~0.2 |
| Component B | |
| HDI | 10 |

An increased drying time was obtained for this composition. The resulting film had high strength, but its cold flexibility and elongation were reduced in comparison to an acrylic paste which does not include polyols.

### Example 5

### Example 5.1

According to some non-limiting embodiments, Ceraclor (plasticizer) and Diethylene glycol (Binder) were added in order to increase elongation and improve cold flexibility. The materials and percentages used for the preparation of water-based two-component polyurethane film are summarized in Table 5.1.

TABLE 5.1
Materials and percentages

| Ingredient | % |
|---|---|
| Component A | |
| Pigment | 2.5 |
| Filler | 34.6 |
| Styrene acrylate emulsion 50% solids, Tg < 20 | 24.0 |
| Polyacrylate dispersion 2% OH content | 30.0 |
| Additives—thickener, dispersing agent, | ~3.5-4 |
| Anti foam, and biocides | |
| Ceraclor | 4.5 |
| Diethylene glycol | 0.5 |
| Water (deionized) | ~0.2 |
| Component B | |
| HDI | 10 |

Examination of the film properties revealed an improvement in the cold flexibility as well as an increase in the elongation percentages.

### Example 5.2

According to some non-limiting embodiments, the ratio between the acrylic emulsion—Styrene acrylate emulsion and polyol (Bayhydrol A 2457) was increased relative to Example 5.1 to approximately 1:3. The materials and percentages used for the preparation of water-based two-component polyurethane film are summarized in Table 5.2.

TABLE 5.2
Materials and percentages

| Ingredient | % |
|---|---|
| Component A | |
| Pigment | 2.5 |
| Filler | 39.6 |
| Styrene acrylate emulsion 50% solids, Tg < 20 | 40.0 |
| Polyacrylate dispersion 2% OH content | 14.0 |
| (Bayhydrol A 2457) | |
| Additives—thickener, dispersing agent, | ~3.5-4 |
| Anti foam, and biocides | |
| Water (deionized) | ~0.2 |
| Component B | |
| HDI | 10 |

Similarly to example 5.1, improvement in the cold flexibility was observed, as well as an increase in the elongation percentages.

### Example 6

According to some non-limiting embodiments, several experiments were conducted in the next step wherein the solids percentage of the entire resins in the composition was increased from 24% to 30%.

### Example 6.1

The materials and percentages used for the preparation of water-based two-component polyurethane film are summarized in Table 6.1.

TABLE 6.1
Materials and percentages

| Ingredient | % |
|---|---|
| Component A | |
| Pigment | 2.5 |
| Filler | 31.1 |
| Styrene acrylate emulsion 50% solids, Tg < 20 | 50.0 |
| Polyacrylate dispersion 2% OH content | 12.5 |
| Additives—thickener, dispersing agent, | ~3.5-4 |
| Anti foam, and biocides | |
| Water (deionized) | ~0.2 |
| Component B | |
| HDI | 5-10 |

### Example 6.2

The materials and percentages used for the preparation of water-based two-component polyurethane film are summarized in Table 6.2.

TABLE 6.2
Materials and percentages

| Ingredient | % |
|---|---|
| Component A | |
| Pigment | 2.5 |
| Filler | 31.1 |
| Styrene acrylate emulsion 50% solids, Tg < 20 | 50.0 |
| Polyester polyurethane dispersion—Binder | 12.5 |
| Additives—thickener, dispersing agent, | ~3.5-4 |
| Anti foam, and biocides | |
| Water (deionized) | ~0.2 |
| Component B | |
| HDI | 5-10 |

### Example 6.3

The materials and percentages used for the preparation of water-based two-component polyurethane film are summarized in Table 6.3.

TABLE 6.3
Materials and percentages

| Ingredient | % |
|---|---|
| Component A | |
| Pigment | 2.5 |
| Filler | 31.1 |
| Pure acryl 60% solids Tg < 0 | 41.7 |
| Polyacrylate dispersion 2% OH content | 12.5 |
| Additives—thickener, dispersing agent, | ~3.5-4 |
| Anti foam, and biocides | |
| Water (deionized) | ~8.5 |
| Component B | |
| HDI | 5-10 |

Component B was added to each of the above compositions in two ratios: 1:10 and 1:20. Drying times and pot life were measured, and dry films were prepared for properties examination.

The following conclusions can be drawn from the results:
When adding 5% of component B, in other words, a 1:20 ratio, the measured tensile strength is lower and the elongation percentage is higher in comparison to 1:10 ratio.
The use of pure acryl significantly reduces the elongation percentage, increases the strength, improves the cold flexibility and shortens the drying time and pot life.
The use of Polyester polyurethane dispersion prolongs the drying time since no reaction occurs between the components due to the lack of free OH groups in component A.

### Example 7

According to some non-limiting embodiments, Pure acryl was added to the composition so that the solids percentages Styrene acrylate: pure acryl is 5:2.

### Example 7.1

The materials and percentages used for the preparation of water-based two-component polyurethane film are summarized in Table 7.1.

TABLE 7.1
Materials and percentages

| Ingredient | % |
|---|---|
| Component A | |
| Pigment | 2.5 |
| Filler | 33.5 |
| Styrene acrylate emulsion 50% solids, Tg < 20 | 35.7 |
| Pure acryl 60% solids Tg < 0 | 11.9 |
| Polyacrylate dispersion 2% OH content | 12.5 |
| Additives—thickener, dispersing agent, | ~3.5-4 |
| Anti foam, and biocides | |
| Water (deionized) | 0.2 |
| Component B | |
| HDI | 5 |

### Example 7.2

The materials and percentages used for the preparation of water-based two-component polyurethane film are summarized in Table 7.2.

TABLE 7.2
Materials and percentages

| Ingredient | % |
|---|---|
| Component A | |
| Pigment | 2.5 |
| Filler | 33.0 |
| Styrene acrylate emulsion 50% solids, Tg < 20 | 35.7 |
| Pure acryl 60% solids Tg < 0 | 11.9 |
| Polyacrylate dispersion 2% OH content | 12.5 |
| Additives—thickener, dispersing agent, | ~3.5-4 |
| Anti foam, and biocides | |
| Water (deionized) | 0.2 |
| Diethylene Glycol | 0.5 |
| Component B | |
| HDI | 5 |

Combining Pure acryl in the composition did not affect the drying profile in comparison to a composition containing only an styrene acrylate emulsion. Nonetheless, pure acryl presence significantly reduces the pot-life. No significant change in properties was observed when diethylene glycol was added.

### Example 8

### Preparation of Two-Component Polyurethane Dispersion

The materials used for the preparation of Component A, according to some embodiments of the invention, are summarized in Table 8.

TABLE 8
The materials used for the preparation of Component A

| Ingredient | |
|---|---|
| Component A | % |
| Pigment | 7.5 |
| Filler | 26.1 |
| Styrene acrylate emulsion 50% solids, Tg < 20 | 50.0 |
| Polyacrylate dispersion 2% OH content | 12.5 |
| Additives—thickener, dispersing agent, | ~3.5-4 |
| Anti foam, and biocides | |

The ratio between the components in the composition is predetermined except for the thickener percentage, which is determined during the final stages of the product (Component A) preparation according to the desired viscosity, as will be specified below.

The ingredients listed in Table 8 are added into a tank under continuous shear in the following order: first, the styrene acrylate emulsion, polyol—polyacrylate dispersion, the solvent and the dispersion agent, which are the liquid ingredients are added to the tank. Next, half a dose of the anti foam agent is added to prevent foaming, and then the powdery ingredients—pigment(s) and filler(s)—are slowly added to the mixture. Finally, after the mixture becomes homogenous, the remaining quantity of the anti foam agent is used. A thickening process follows, wherein the viscosity is adjusted to the desired value of 45,000-50,000 cP. Finally, after obtaining a homogenous mixture, a degassing process is conducted.

The two-component polyurethane dispersions was prepared by mixing component A with component B (Bayhydur xp 2451 from Bayer), containing hydrophilic aliphatic polyisocyanate (HDI)) at ratio (A:B) of 20:1. Mixing of component A with component B was conducted as close as possible to the application time.

### Example 9

### Technical Properties of the Two-Component Polyurethane Membrane

The technical properties of Component A, Component B and the two-component polyurethane membrane are illustrated in Table 9.

TABLE 9
The technical properties of Component A, Component
B and the two-component polyurethane membrane

| | Property | | |
|---|---|---|---|
| Description | Component A | Component B | Standard |
| Appearance | Top Layer: White | Transparent paste | |
| | Base Layer: Peach | | |
| Specific gravity | 1.28 | 1.15 | |
| | Product specific gravity 1.3 | | |
| Solid content | >64% | 100% | |
| Mixing ratio by weight | 20 | 1 | |
| Pot life | 3 | hours | |
| Tack free time @25° & 55% RH | 6 | hours | |
| Coverage | 2.5-3.5 | kg/m² | |
| Dry film thickness | 1.3-1.85 | mm | |
| Service temperature | −10° C. to +60° C. | | |
| Application temperature | +5° C. to 40° C. | | |
| Heat stability | >120° | C. | ASTM D 2939 |
| | (>248° | F.) | |
| cold flexibility | <−17° | C. | ASTM D 522 |
| Hardness | 40-50 | Shore A | ASTM D 2240 |
| Tensile Strength | >2.5 | Mpa | ASTM D 412 |
| Elongation at break | >200% | | ASTM D 412 |
| Resistance to ponding water | Pass | | ASTM D 2939 |
| Resistance to water pressure | 0.5 atm, 24 hr | | DIN 52123 |
| Water absorption | 8.5% | | DIN 53495 |
| Water Vapor Permeance | <10 | perms | ASTM D 1653 |
| Tear Resistance | >130 | N/cm | ASTM D 624 |

| | | |
|---|---|---|
| Solar Reflectance | >85% | ASTM C 1549 |
| Infrared Emittance | >85% | ASTM C 1371 |
| Adhesion | Excellent to: concrete, Bituminous membrane, bitumen, | ASTM C 794 |
| | Aluminum, Galvanized steel, asbestos, etc. | |

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A water-based two-component polyurethane dispersion prepared from:
(a) an aqueous polymer emulsion comprising, as separate components, one or more emulsifiable polymers and one or more polyols, wherein the aqueous polymer emulsion has a Tg lower than about 20° C.; and
(b) one or more isocyanates.

2. The dispersion according to claim 1, wherein the one or more emulsifiable polymers comprises an acrylic polymer.

3. The dispersion according to claim 1, wherein the aqueous polymer emulsion (a) has a Tg in the range of about 15° C. to −30° C.

4. The dispersion according to claim 1, wherein the OH groups content in the one or more polyols in the aqueous polymer emulsion (a) is in the range of about 0.01%-5%.

5-6. (canceled)

7. The dispersion according to claim 1, wherein the ratio between the OH groups content in the one or more polyols in the aqueous polymer emulsion (a) and the —NCO groups content of the one or more isocyanates (b) is in the range of about 1:3 to about 1:15.

8. (canceled)

9. The dispersion according to claim 1, wherein the one or more polyols are provided from one or more water soluble polyesters, polyester emulsions, polyurethane dispersions, fatty acid modified polyurethane dispersion, polyester/polyacrylate hybrids, polyester/polyurethane hybrids, primary polyacrylic emulsions, secondary polyacrylic emulsions or any combinations thereof.

10. The dispersion according to claim 2, wherein the one or more acrylic polymers comprise acrylates selected from the group consisting of butyl acrylate, 2-ethylhexyl acrylate, methyl acrylate, ethyl acrylate, acrylonitrile, methyl methacrylate, vinyl acrylate and trimethylolpropane triacrylate.

11. The dispersion according to claim 2, wherein the one or more acrylic polymers comprise acrylic copolymer.

12. The dispersion according to claim 11, wherein the acrylic copolymers comprise copolymers of acrylics with styrene, substituted styrene, vinyl chloride, vinyl acetate, butadiene, acrylonitrile butyl acrylate, methyl acrylate, vinyl acrylate, 2-ethylhexyl acrylate, ethyl acrylate, methyl methacrylate, trimethylolpropane triacrylate or any combination thereof.

13. The dispersion according to claim 11, wherein the acrylic copolymer comprises a polystyrene acrylate copolymer.

14. The dispersion according to claim 1, wherein the aqueous polymer emulsion further comprises one or more of vinyl acetate polymers, vinyl acetate copolymers, ethylene copolymers, alky resins, polyamides, polyacetals, polycarbonates, polyketones, polyethers, polyurea polyurethanes or any combinations thereof.

15. The dispersion according to claim 1, wherein the one or more isocyanates comprise polyisocyanates.

16. The dispersion according to claim 1, wherein the one or more isocyanates comprises aliphatic isocyanates, cycloaliphatic isocyanates, aromatic isocyanates, or any combination thereof.

17. The dispersion according to claim 1, wherein the one or more isocyanates comprise methylene diphenyl diisocyanate (MDI), toluene diisocyanate (TDI), hexamethylene diisocyanate (HDI) and isophorone diisocyanate (IPDI) or any combination thereof.

18. The dispersion according to claim 1, adapted for application as a water resistant layer.

19. The dispersion according to claim 1, adapted for application as a water resistant isolation layer having a thickness of about 0.1 millimeter (mm) or more.

20-33. (canceled)

34. A process for the preparation of water-based two-component polyurethane dispersion, the process comprising combining:
(a) an aqueous polymer emulsion comprising one or more emulsifiable polymers and, as separate components, one or more polyols, wherein the aqueous polymer emulsion has a Tg lower than about 20° C.; and
(b) one or more isocyanates.

35. The process according to claim 34, wherein the one or more emulsifiable polymers comprise an acrylic polymer.

36-52. (canceled)

53. An essentially water resistant coating substance comprising water-based two-component polyurethane dispersion prepared from combining:
(a) an aqueous polymer emulsion comprising one or more emulsifiable polymers and, as separate components, one or more polyols, wherein the aqueous polymer emulsion has a Tg lower than about 20° C.; and
(b) one or more isocyanates.

54. The coating substance according to claim 53, wherein the one or more emulsifiable polymers comprise an acrylic polymer.

55. The coating substance according to claim 53, having a thickness of at least about 0.1 millimeter (mm)

56. The coating substance according to claim 53, having cold flexibility lower than about −10° C. (according to ASTM D 522 standard).

57. The coating substance according to claim 53, having tensile strength higher than about 2.0 Mpa (according to ASTM D 412 standard).

58. The coating substance according to claim 53, having elongation at break higher than about 100% (according to ASTM D 412 standard).

59. The coating substance according to claim 53, having water absorption lower than about 10% (according to DIN 53495 standard).

60. (canceled)
